(19) United States
(12) Patent Application Publication
(10) Pub. No.: US 2025/0247714 A1
(43) Pub. Date: Jul. 31, 2025

(54) SYSTEM AND METHODS FOR MACHINE LEARNING ASSISTED ENERGY SAVING IN A RADIO ACCESS NETWORK

(71) Applicant: Aira Technologies, Inc., Saratoga, CA (US)

(72) Inventors: Yihan Jiang, Cupertino, CA (US); Babak Jafarian, Mountain View, CA (US); RaviKiran Gopalan, Saratoga, CA (US); Anand Chandrasekher, Saratoga, CA (US)

(21) Appl. No.: 19/039,096

(22) Filed: Jan. 28, 2025

Related U.S. Application Data
(60) Provisional application No. 63/626,427, filed on Jan. 29, 2024.

(51) Int. Cl. H04W 16/22; H04W 52/02

(52) U.S. Cl. CPC H04W 16/22; H04W 52/0216

(57) ABSTRACT

This disclosure relates to methods, systems, and devices for system and methods for machine learning assisted energy saving in a radio access network (RAN). A network emulator may be trained to emulate a RAN using data from a network operator of the RAN. The trained emulator may then be used to generate synthetic network data. A neural predictor may be trained, first with the synthetic network data, and then with fine tuning using the operator data. Next, the model may be trained using shadowing data from the RAN while monitoring an uncertainty of the output of the neural predictor. When the uncertainty of the output falls below a threshold, the neural predictor may be trained using reinforcement learning, gradually increasing trust in the neural predictor. Finally, the neural predictor may be used to control the RAN.

### CROSS-REFERENCE TO RELATED APPLICATION

This application claims the benefit of and priority to U.S. Provisional Patent Application No. 63/626,427, entitled “SYSTEM AND METHODS FOR MACHINE LEARNING ASSISTED ENERGY SAVING IN A RADIO ACCESS NETWORK”, filed on Jan. 29, 2024, which is incorporated herein by reference in its entirety.

### TECHNICAL FIELD

The present disclosure relates to machine learning-based control of radio access networks (RANs). More specifically, the disclosure pertains to systems and methods for energy-efficient operation of RANs by using neural networks trained with real, synthetic, and shadowing data to predict network performance and control network components such as base stations, radio carriers, and antennas.

### BACKGROUND

Radio Access Networks (RAN) such as 5G RAN networks consume very large amounts of energy. Network operators therefore manage these networks to save energy without affecting user experiences. For example, bands and cells that are heavily used during peak hours can be put into sleep mode or shut down during non-peak hours. Research shows that, if performed efficiently, such management could save a significant amount of the total energy consumption of the entire network.

However, current network management techniques do not achieve such savings. Current network management methods are based on analytics and heuristics. Typically network analysts monitor network data, manually determine non-peak times, and then hard-code shutdown rules for those non-peak times.

Such rule-based systems rely heavily on manual human evaluation using dashboards. These approaches have several drawbacks. First, the predicted performance of key performance indicators (KPIs) may be wrong. Second, the reasoning used to control and affect KPIs, and the desired features are heuristics, for example to minimize energy consumption while keeping customer satisfaction unchanged. Typical KPIs include packet loss, throughput, quality of service, and latency. Heuristics are not guaranteed to be correct. Third, the robustness of these approaches in a dynamic environment is questionable. Fourth, the manual nature of this approach, for different geolocations and environments, requires tedious and error-prone case-by-case adaptation.

### SUMMARY

Recently, machine learning (ML) approaches have emerged as a way to optimize energy consumption in RANs. These ML approaches are typically built on time-series prediction of KPIs. Based on the KPI predictions, energy saving actions are chosen.

Current ML approaches have several drawbacks as well. First, real-world datasets are typically imbalanced and sparse. ML algorithms require a balanced dataset in order to generate accurately performing models under all possible conditions, but network operators do not offer balanced data. That is, network operators offer data that is referred to herein as “sunny day data,” but do not offer data that is referred to herein as “rainy day data.” Sunny day data is the data seen when all sites are fixed on, which is typical. Rainy day data is the data seen when capacity is reduced, which is rare. Reduced capacity can be accomplished by powering off certain sites, certain radio bands, or restricting the number of spatial streams allowing a powering off of associated transmit chains, including the typically power-hungry RF power amplifiers. In the following description, “sunny day data” and “normal-operation data” are used interchangeably, and “rainy day data” and “restricted-operation data” are used interchangeably.

FIG. 1 illustrates network data in the form of a Venn diagram. Sunny day data 102 and rainy-day data 104 do not overlap. And the available data 106 within the sunny day data 102 is sparse. However, a larger challenge is the absence of rainy-day data. The real network is mission-critical, so negative data points are very hard to obtain. That is, network operators will not allow ML algorithms to do bad resource allocation just to collect more data as the resulting poor network performance leads to user churn.

Self-driving cars provide a good analogy. Sunny day data reflects when a car operates normally; rainy day data reflects when a car crashes. Some crash data (rainy day data) is needed to learn to avoid crashes, but we cannot design an algorithm to intentionally crash cars to obtain rainy day crash data.

Existing ML network management solutions use available data to generate a ML-based traffic predictor, and then infer configuration according to the predictor. But available data does not include rainy day data. Without rainy day data, this approach is less reliable.

As with rule-based approaches, the robustness of ML approaches in a changing environment is questionable. Furthermore, ML algorithms are missing an uncertainty component. For these reasons, it cannot be determined when an ML algorithm can be trusted. In addition, traffic patterns may change, for example with increasing 5G adoption, and an increase in the number of users and/or data consumption patterns.

In accordance with one or more embodiments, various features and functionalities are provided to achieve energy saving in a radio access network (RAN).

In one general aspect, the system may include one or more hardware processors. It may also include one or more non-transitory machine-readable storage media encoded with instructions that, when executed by the one or more hardware processors, cause the system to perform various operations. These operations may include training a network emulator to emulate a radio access network (RAN) using network operator data of the RAN. The operations may further include generating synthetic network data using the trained emulator and training a neural predictor with the synthetic network data. Additionally, the operations may include training the neural predictor using the operator data and shadowing data of the RAN while monitoring the uncertainty of the neural predictor's output. When the uncertainty of the output falls below a threshold, the system may train the neural predictor using reinforcement learning. Furthermore, the system may control the RAN using the neural predictor.

The operations may include collecting third data during a shadowing phase, where the shadowing phase includes passively monitoring network operations without sending control instructions to the network. The third data may include performance data observed from both normal-operation scenarios and restricted-operation scenarios. The method may further include augmenting the training dataset of the neural predictor by incrementally integrating the third data with the first or second data, followed by fine-tuning the neural predictor using the augmented training dataset to reduce predictive uncertainty in conditions underrepresented by the first data and to correct biases in the second data.

The fine-tuning step may include periodically updating the neural predictor using the newly collected third data during maintenance windows or in near real-time to incrementally refine the neural predictor's predictions for both typical and edge-case network scenarios. The fine-tuning step may also include combining the third data with the first data as the augmented training dataset and retraining the neural predictor using the augmented training dataset to reduce uncertainty scores in low-data regions and mitigate over-reliance on synthetic data in the second data.

Training the network emulator to align the second data with the first data may include applying Bayesian optimization with an upper confidence bound acquisition function to adjust one or more parameters of the network emulator, with the adjustments being guided by a reward function that quantifies the degree of alignment between the first and second data. The reward function may be computed on a per-site basis using key performance indicators (KPIs) for each base station in the second data and comparing them to corresponding KPIs in the first data. The per-site comparisons may then be aggregated into a global alignment score used to guide the parameter adjustments.

The parameters of the network emulator may include at least one parameter for mobile user equipment (UEs) and stationary UEs at each site, at least one throughput-related parameter for mobile and stationary UEs, and at least one speed parameter for stationary UEs.

Controlling one or more base stations in the RAN may include projecting user traffic levels within a cluster of base stations based on the output of the neural predictor. The system may selectively deactivate one or more radio carriers, frequency bands, or entire sectors when the projected traffic levels indicate low demand, thereby reducing power consumption during off-peak hours. The system may also reroute user traffic onto remaining active carriers to maintain service continuity.

In some embodiments, controlling one or more base stations in the RAN may include obtaining predicted traffic distributions among a plurality of cells or sites based on the output of the neural predictor. The system may adjust the transmit power levels or antenna configurations of the plurality of cells or sites according to the predicted traffic distributions to conserve energy in geographic areas with lower user demand. The system may also automatically modulate the transmission power output of the plurality of cells or sites to align with predicted user demands while using reduced energy expenditure. Additionally, the system may increase transmit power output in response to predicted coverage needs in specific geographic areas to prevent service degradation and maintain throughput targets.

In some embodiments, the neural predictor may include an intra-cell neural network configured to capture site-specific features, a time-series neural network configured to extract temporal dependencies, and a transformer encoder configured to model inter-site interactions. The site-specific features captured by the intra-cell neural network may include KPIs, past actions, and proposed future actions. The intra-cell neural network may include a fully connected neural network that transforms the site-specific features into a compact latent representation, thereby enabling subsequent stages to operate with reduced dimensionality.

In some embodiments, the temporal dependencies may include both normal and restricted operations in network usage, interference levels, and user behaviors. The time-series neural network may use at least one of a Transformer Decoder, Long Short-Term Memory (LSTM) network, or Gated Recurrent Unit (GRU) network to generate a time-evolving feature vector for each site. To model inter-site interactions, the transformer encoder may track interactions among neighboring base stations, including spillover effects and user redistribution.

In one general aspect, a method may be implemented by the system, and includes receiving first data collected from the RAN, where the first data may include imbalanced normal-operation data and restricted-operation data. The method may further include generating second data using a network emulator, where the second data includes synthetic normal-operation data and synthetic restricted-operation data. The method may further include training the network emulator to align the second data with the first data by adjusting the emulator's parameters. The method may further include training a neural predictor using the aligned second data, where the neural predictor predicts network performance metrics and generates uncertainty scores about the predicted metrics. The method may further include controlling one or more base stations in the RAN based on the neural predictor's output, where the control includes sending instructions to selectively reduce capacity during periods of low traffic to achieve energy savings.

In one general aspect, a non-transitory computer-readable storage medium may store instructions that include receiving first data collected from the RAN, where the first data may include imbalanced normal-operation data and restricted-operation data. The instructions may further include generating second data using a network emulator, where the second data includes synthetic normal-operation data and synthetic restricted-operation data. The instructions may include training the network emulator to align the second data with the first data by adjusting the emulator's parameters. Additionally, the instructions may include training a neural predictor using the aligned second data, where the neural predictor predicts network performance metrics and generates uncertainty scores. The instructions may also include controlling one or more base stations in the RAN based on the neural predictor's output, where the control includes sending instructions to selectively reduce capacity during low-traffic periods to achieve energy savings.

Other features and aspects of the disclosed technology will become apparent from the following detailed description, taken in conjunction with the accompanying drawings, which illustrate by way of example, the features in accordance with embodiments of the disclosed technology. The summary is not intended to limit the scope of any inventions described herein, which are solely defined by the claims attached hereto.

### BRIEF DESCRIPTION OF THE DRAWINGS

The technology disclosed herein, in accordance with one or more various embodiments, is described in detail with reference to the following figures (hereafter referred to as “FIGs”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates network data in the form of a Venn diagram.

FIG. 2 is a flowchart illustrating a process for machine learning assisted energy saving in a radio access network (RAN) according to some embodiments of the disclosed technology.

FIG. 3 is a block diagram illustrating a data alignment process according to some embodiments of the disclosed technology.

FIG. 4 illustrates an example base station layout.

FIGS. 5A and 5B illustrate data alignment results for the data alignment process of FIG. 3 and the example base station layout of FIG. 4.

FIG. 6 illustrates an architecture of a neural predictor according to some embodiments of the disclosed technology.

FIGS. 7A and 7B illustrate two possible network control and optimization strategies. FIG. 7A illustrates jointly optimizing the sites within a fixed distance R from the candidate “center site.” FIG. 7B illustrates optimizing sites individually but taking into account the nearest neighboring sites.

FIG. 8 illustrates an example computing system that may be used in implementing various features of embodiments of the disclosed technology.

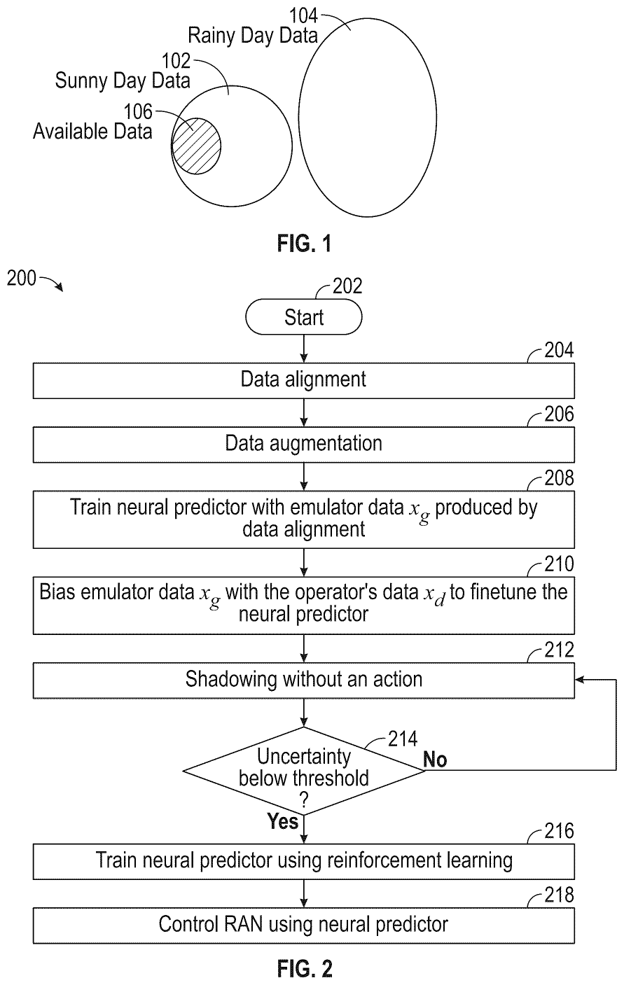

### DETAILED DESCRIPTION

FIG. 2 is a flowchart illustrating a process 200 for machine learning assisted energy saving in a radio access network (RAN) according to some embodiments of the disclosed technology. The process 200 may be implemented by a base station in the RAN.

The elements of the disclosed processes are presented in one arrangement. However, it should be understood that one or more elements of the processes may be performed in a different order, in parallel, omitted entirely, and the like. Furthermore, the processes may include other elements in addition to those presented. For example, the processes may include error-handling functions if exceptions occur, and the like.

The process 200 may implement reinforcement learning (RL). RL is known to be unstable, and could be catastrophic in real production systems. In order to gradually enable RL, the process 200 proceeds in multiple stages.

The described processes may employ three types of data: operator's data x_{D}, emulator data x_{G}, and shadowing data x_{S}. As noted above, the operator's data x_{D} is real data and accurate, but is sparse, and typically includes no rainy-day data. In contrast, the emulator data x_{G} is abundant and includes both sunny day data and rainy-day data, but being synthetic data, may be biased and of low quality. The shadowing data x_{S} is real data, accurate, and includes both sunny day data and rainy-day data, but is collected gradually and is only available when shadowing real RANs. The shadowing process does not involve sending control instructions to the network, such as shutting down a base station to generate more “rainy day” data. Instead, it passively collects data as the RAN operates under its typical configuration or during real incidents. Unlike simulation or synthetic data generation, where large amounts of data can be created quickly, real-world network data accumulates slowly over time as different network conditions naturally occur. For example, “rainy day” data may only become available during maintenance events, outages, or temporary capacity reductions.

Referring to FIG. 2, the process 200 may start at 202. The process 200 may begin with data alignment, at 204. As noted above, the operator's data x_{D} is sparse and imbalanced. The operator's data x_{D} is sparse because only a few days of data are available, and only for a few base stations. The operator's data x_{D} is imbalanced due to the lack of rainy-day data because typically operators do not restrict the capacity base stations, so that the data only experiences single configurations, as sunny day data.

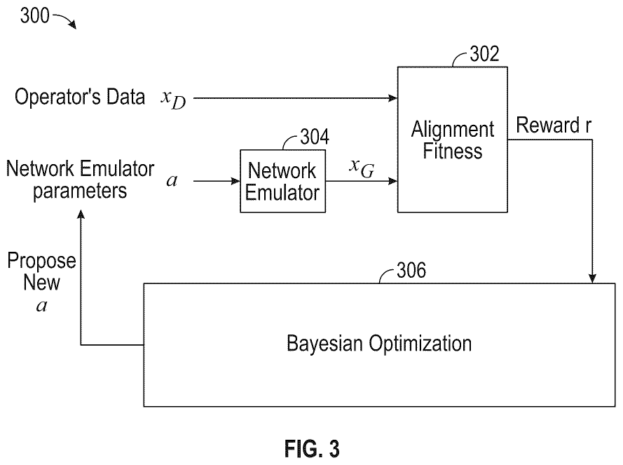

Some embodiments employ an emulator to generate additional data x_{G}, and a data alignment process to cause that data x_{G} to more closely resemble the operator's data x_{D}. FIG. 3 is a block diagram illustrating a data alignment process 300 according to some embodiments of the disclosed technology. Referring to FIG. 3, an alignment fitness process 302 receives operator's data x_{D} from the RAN operator and emulator data x_{G} from a network emulator 304 that operates according to network emulator parameters a. The alignment fitness process 302 generates a reward r representing the degree of alignment of the operator's data x_{D} and the emulator data x_{G}. The alignment fitness process 302 may employ any suitable algorithm(s). For example, the reward may be a vector dot product of the operator's data x_{D} and the emulator data x_{G}. The vector dot product measures the similarity between two vectors by calculating the sum of the element-wise multiplications of their corresponding values. When applied to the operator's data x_{D} and the emulator data x_{G}, a higher dot product value indicates a stronger alignment, as it reflects that the vectors point in similar directions within the feature space. Conversely, if the dot product is close to zero or negative, it suggests a weak alignment or orthogonal relationship between the data sets, indicating discrepancies between the synthetic and real data. As another example, the weighted normalized MSE may be used to compute the reward, for example according to formula (1), where weight w_{g} is predefined based on knowledge of the feature.

$${w}_{g} \sum {( {x}_{G} - {x}_{D} )}^{2} \qquad ( 1 )$$

An optimization process 306 may be employed to maximize the reward by modifying the network emulator parameters a. The optimization process 306 may include Bayesian optimization, which produces multiple possible solutions. The Bayesian optimization may employ an upper confidence bound (UCB) acquisition function. Site-wise loss (average across dimensions) may be used to align KPI averaged per site, so that it is not necessary to deal with high dimensionality data alignment. The reward may be computed per site, and those rewards may be summed to find the final reward.

For example, the optimization process begins by initializing a set of network emulator parameters and running the emulator to generate synthetic data. A surrogate model—such as a Gaussian process—is then used to estimate the relationship between these parameters and the alignment reward. The “reward” represents how well the synthetic data aligns with the real data, and this alignment is often computed for specific features that describe network performance, such as throughput, user count, or power consumption-collectively referred to as key performance indicators (KPIs).

During this process, the UCB acquisition function may be used to guide the selection of which parameter values to evaluate next, balancing exploration (finding entirely new parameter regions) and exploitation (focusing on promising parameters identified so far). Each time a candidate parameter set is tested, the resulting alignment reward is measured, and the surrogate model is updated with this new data point. Repeating this process iteratively allows the Bayesian optimization framework to adjust the emulator parameters that maximize alignment with the operator's real network data.

Each base station (e.g., site) contributes its own KPIs, which describe different aspects of network performance for that site. In large networks with many sites, these KPIs can form a high-dimensional dataset. Instead of comparing the full set of KPIs for all sites as a single, massive vector, the system simplifies the alignment process by breaking it down site by site. Specifically, for each site, it calculates how closely the emulator's synthetic data matches the real operator data for the relevant KPIs of that site, producing a “site-wise loss” (i.e., a measure of misalignment for that specific site). This loss might be computed as a weighted mean square error (MSE) for the KPIs at the site level.

Once a site-wise loss is computed for each site, the losses from all sites are summed or averaged to produce a final overall reward. This approach allows the optimization process to focus on local alignment at individual sites and then aggregate these local results into a single global reward that represents the overall alignment of the synthetic data to the real data across the network. This step helps reduce the complexity of directly comparing massive, network-wide KPI datasets and makes Bayesian optimization more computationally manageable.

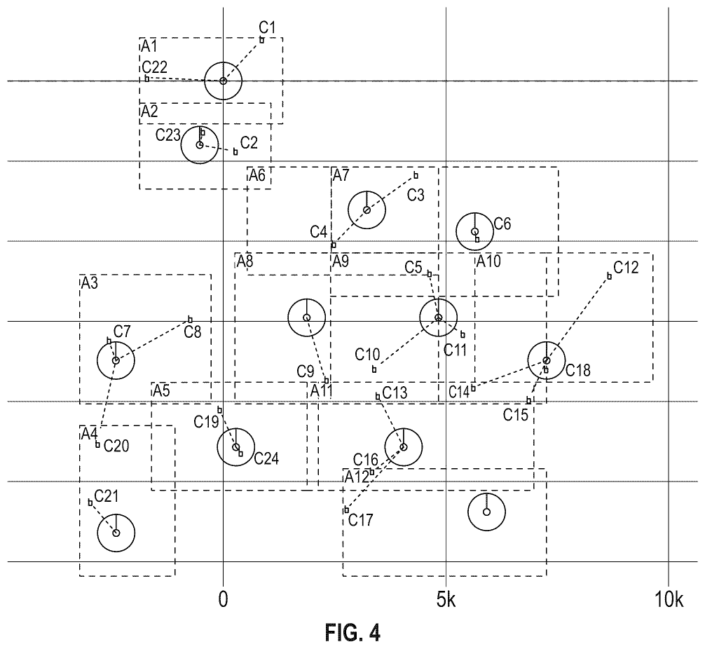

The operator's data x_{D} and the emulator data x_{G} may be of the same shape, and may be highly dimensional. Example network emulator parameters a are described for the example base station layout of FIG. 4. Referring to FIG. 4, the example base station layout includes 12 regions A1-A12 indicated by broken-line rectangles. Each region includes one base station. Also shown are User End Devices (UEs) C1-C24. A broken line between a UE and a base station indicates the UE is attached to the base station. For the example base station layout of FIG. 4, the network emulator parameters a may have 15 dimensions, which may include (1) 12 areas, each having one parameter for mobile UEs and one parameter for stationary UEs, (2) desired throughput and speed of the mobile UEs, and (3) desired throughput of the stationary UEs. Parameters (2) and (3) may be global to accommodate limitations of the network emulator 304.

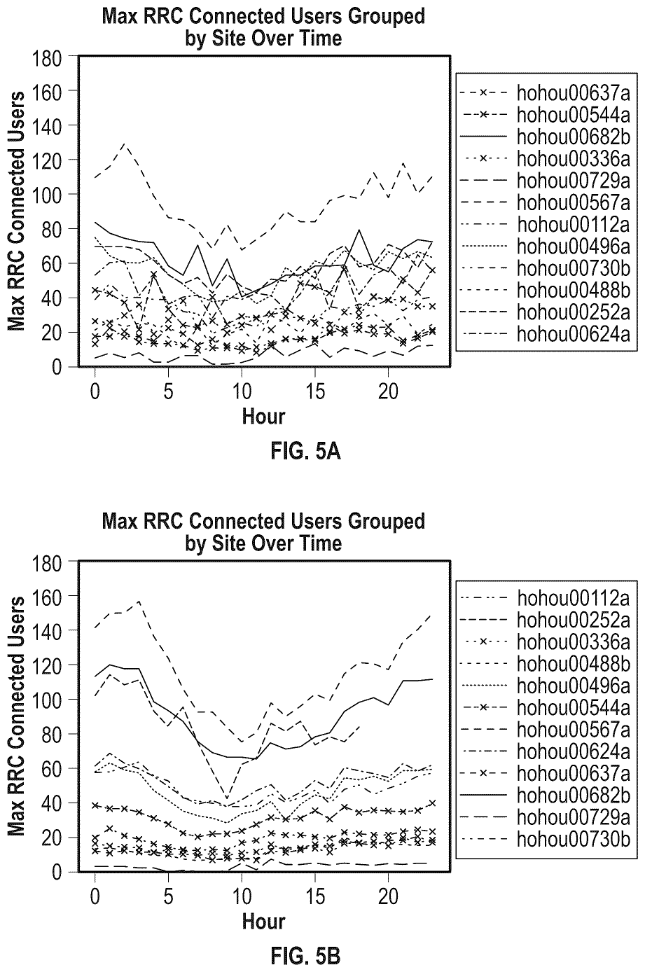

FIGS. 5A and 5B illustrate data alignment results for the data alignment process 300 of FIG. 3 and the example base station layout of FIG. 4. In particular, each of FIGS. 5A and 5B illustrate maximum connected users grouped by base station (i.e., site) over time. The metric represents the maximum number of users simultaneously connected to a base station at the RRC level during a given period. It provides an important performance indicator for network load. When too many users are connected at the RRC level, the base station may experience resource contention, leading to degraded performance or even connection failures. FIG. 5A illustrates results produced by the network emulator, while FIG. 5B illustrates results produced by the RAN.

Referring again to FIG. 2, the process 200 may continue with data augmentation, at 206. In this step, the now-aligned network emulator 304 may be used to generate additional emulator data x_{G}.

The process 200 may continue with training a neural predictor with the emulator data x_{G} produced by the data alignment process, at 208. This process may involve feeding input features and corresponding targets derived from x_{G} into the neural network, using supervised-learning routines such as forward propagation followed by backpropagation. Although alignment aims to reduce discrepancies, synthetic data may still diverge from the real-world distributions observed in operator data, so the network can exhibit heightened epistemic and/or aleatoric uncertainty when trained solely on x_{G}. One way to track this uncertainty is through a specialized loss function—an “uncertainty loss”—designed to capture how confident the neural predictor is about its outputs. As the emulator data may not fully mirror every edge case of real network behavior, the resulting initial training phase can lead to higher overall uncertainty, which requires subsequent fine-tuning with operator data or gradual retraining with shadowing data to reduce predictive uncertainty in conditions underrepresented by the operator's data x_{D} and correct biases in the synthetic emulator data x_{G}, thereby improving model reliability.

For example, the neural predictor can be exposed to the operator data that has been verified to reflect actual network conditions but may be sparse. This step adjusts the neural predictor's weights to reduce uncertainty in those operating regimes accurately represented by the real data. In another example, the model may be retrained or continuously updated using shadowing data collected from the live network. Because shadowing data captures both typical and less common conditions without intervention, integrating it incrementally refines the model's parameters and stabilizes its performance, thereby lowering the overall uncertainty and improving reliability across a broader range of potential network scenarios. This staged training approach—from synthetic data to real operator data to shadowing data—ensures that while the model benefits from abundant emulator data, it does not become over-reliant on artificially generated samples and instead converges to a more trustworthy representation of real-world RAN behavior.

The overall training strategy can be viewed as a layered approach, in which data alignment and initial model training happen at a slower tempo, while subsequent fine-tuning on shadowing data follows a faster, more continuous schedule. After the emulator parameters have been optimized to generate synthetic data closely mirroring real-world operator data, the neural predictor may undergo an iterative training phase—often repeated on a longer timescale (e.g., monthly or quarterly)—to incorporate any newly available operator data and periodically refresh its underlying parameters. This process ensures that the emulator does not drift too far from real-network behavior as conditions evolve over time.

In contrast, the shadowing phase represents a more immediate refinement loop. Because shadowing data is collected continuously from the actual network, it can be integrated into the model on a shorter cadence, potentially in near real-time or during daily maintenance windows. Each small batch of newly gathered data updates the model incrementally, allowing the neural predictor to refine its predictions over time for both typical network scenarios and edge-case conditions, such as temporary capacity reductions or outages. This dual-cadence training scheme balances the stability of less frequent, large-scale alignment efforts with the agility of continuous fine-tuning.

The process 200 may continue with biasing the emulator data x_{G} with the operator's data x_{D} to fine-tune the neural predictor, at 210. Because the operator's data x_{D} includes only sunny day data, the result will have high uncertainty on rainy days, but low uncertainty on sunny days.

The process 200 may continue with shadowing without an action, at 212. In this phase, the neural predictor is trained with shadowing data x_{S}. As noted above, shadowing data x_{S} is real network data that includes both sunny day data and rainy-day data. During training, uncertainty of the output of the neural predictor is monitored, for example using mean square error. This process gradually increases trust in the neural predictor. When the uncertainty of the output falls below a threshold, at 214, the neural predictor may be trained using reinforcement learning, at 216.

When new data contradicts the model's prediction (both reward and uncertainty), enough data is collected to perform online learning. In this phase, training the model continues with newly collected data.

Finally, the neural predictor may be used to control the RAN, at 218, e.g., to strategically reduce power consumption across the RAN. One example scenario involves per-site dynamic capacity management, where the neural predictor projects that traffic within a cluster of base stations will be low enough to deactivate select radio carriers or even entire sectors without risking coverage gaps. Based on this forecast, the radio controller is instructed to switch off power amplifiers for specific frequency bands or MIMO chains, and to reroute traffic onto any remaining active carriers. This approach allows operators to lower overall power consumption during off-peak hours, while the model's built-in uncertainty measures ensure that performance thresholds and service continuity are maintained.

In another example, the neural predictor obtains predicts traffic distributions among a plurality of cells or sites based on its output. The system adjusts the transmit power levels or antenna configurations of the plurality of cells or sites according to the predicted traffic distributions to conserve energy in geographic areas with lower user demand. In particular, the system automatically modulates transmission power output to align with the predicted user demands while minimizing energy expenditure. Additionally, when the predicted coverage needs indicate increased demand in specific geographic areas, the system increases the transmit power output to prevent service degradation and maintain target throughput levels, thereby ensuring a balance between network efficiency and performance reliability.

In other embodiments, the neural predictor collaborates with network slicing or service orchestration layers to further optimize power usage. By examining historical traffic data, forecasting future demand, and measuring the uncertainty of such predictions, the model recommends how to partition network resources for different slices. For instance, in best-effort areas, the model might limit power allocation and spectrum usage to conserve energy. In contrast, for ultra-low-latency services, the system can maintain sufficient capacity to meet stringent requirements. This dynamic resource allocation ensures that each slice operates with the least power necessary, while still adhering to service-level agreements.

Across these use cases, the neural predictor's understanding of both typical “sunny day” and less common “rainy day” network behavior underpins effective energy-saving measures. By selectively deactivating network elements, adjusting transmit power, or reallocating spectrum resources in line with predicted traffic conditions, operators can significantly cut power consumption.

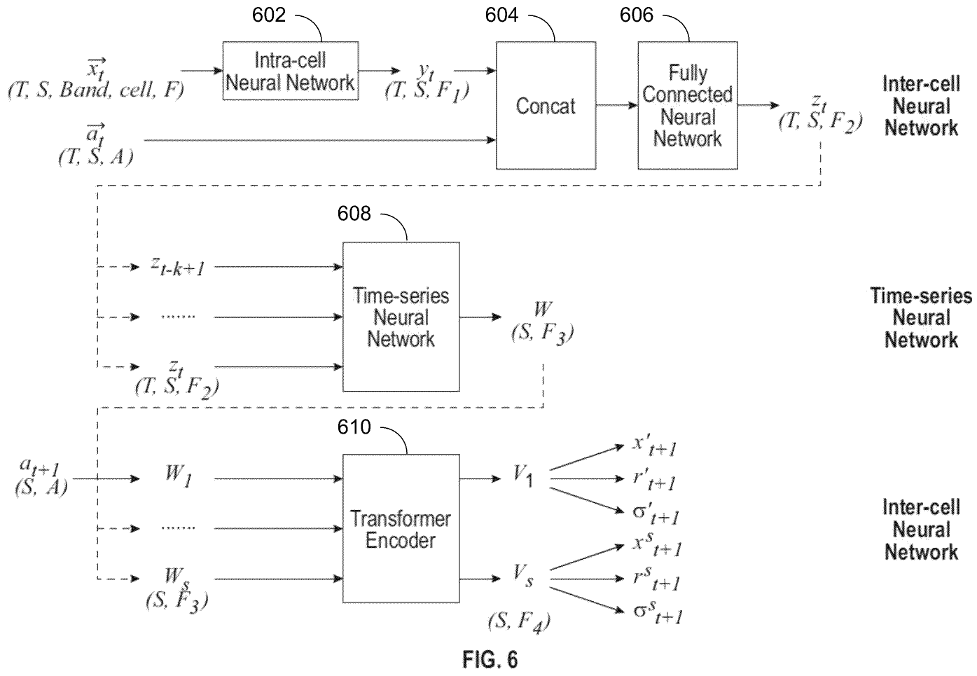

FIG. 6 illustrates an architecture of a neural predictor according to some embodiments of the disclosed technology. Referring to FIG. 6, the neural predictor may include an intra-cell neural network 602, a concatenator 604, a fully-connected neural network 606, a time-series neural network 608, and a transformer encoder 610. In FIG. 6, T represents time, S represents the number of base station sites, Band represents the number of bands, Cell represents the number of cell sectors, F represents the input feature size, A represents the action space, and z represents historical features.

The inputs to the neural predictor are:
Past KPI xₜ data shape (T, S, Band, Cell, F);
Past action at data shape (T, S, A); and
Proposed action aₜ₊₁ data shape (S, A).

The outputs of the neural predictor are the site-wise feature V that comprises:
KPI xₜ₊₁ data shape (S, Band, Cell, F);
Reward metrics rei data shape (S, 2), where dim=2 indicates throughput and power; and
Uncertainty σₜ₊₁ with neural network, which has the same shape (S, 2) as the reward metrics.

In some embodiments, the neural network includes four stages. The first is intra-site feature learning. For each site, the system generates an information feature based on the site's KPIs, past actions, and proposed actions. In this process, the KPIs may be represented by a high-dimension vector, including metrics such as throughput, user load, and power usage across multiple carrier bands or cell sectors. The past actions and proposed actions may include reducing and increasing the capacity at a site, and may represent multiple bands and cell azimuth, or changing the number of active antennas or shifting power levels. This stage may be implemented using the intra-cell neural network 602 and fully-connected neural network 606 of FIG. 6. By integrating these diverse inputs into a coherent feature vector, the model gains an internal representation of the site's operating context. The fully-connected neural network then refines this representation, reducing dimensionality and extracting latent factors, so that all subsequent stages have a compact, high-quality embedding of how the site is performing and what actions are being considered.

The second stage is time series feature learning. In practice, network usage patterns, interference levels, and user behaviors vary over time, requiring the model to understand trends, periodicities, and sudden changes. In this stage, the system generates feature W by tracking and historical features z. Feature W contains the site's trending information. This stage may be implemented using Transformer Decoder, Long Short-Term Memory (LSTM), and Gated Recurrent Units (GRU).

The third stage is inter-site feature learning. In this stage, the system tracks inter-site information, which accounts for interactions among neighboring base stations. For example, when a specific site is reducing capacity, the network may offload to neighboring sites. To capture these spillover effects, some embodiments incorporate a transformer encoder that builds a contextual representation across all sites simultaneously. Each site's embedding, produced from the previous stages, is treated as a token in the encoder, which then uses attention layers to measure pairwise correlations and capture relevant neighbor dependencies. This design ensures that the model does not treat each site in isolation but acknowledges the fluidity of user distribution and cell overlap. By encoding these inter-site relationships, the model can more accurately predict how an action in one site might ripple through the rest of the network. This stage may be implemented using the transformer encoder 610 of FIG. 6.

The fourth stage is final processing heads, transforming the resulting site-wise embeddings into explicit predictions. In this stage, the system maps the site-wise feature V to the desired output. This stage may be implemented using a reshaping Multilayer Perceptron (MLP) to map each site's embedding to specific outputs, which may include KPI forecasts for the next time step, reward metrics such as throughput and power consumption, and uncertainty estimates indicating the model's confidence in its predictions. By separating this step into a distinct processing head, the system can flexibly incorporate different prediction targets or custom loss functions without altering the preceding layers. For instance, if a new KPI becomes relevant or if power consumption needs to be weighted differently in the optimization, developers can adjust the final MLP architecture while reusing the same feature transformations learned in the earlier stages. This modular design also simplifies ongoing maintenance and allows the model to be extended to new use cases as the network evolves.

As shown in FIG. 6, the output of stage 1 may be used as the input of stage 2, the output of stage 2 may be used as the input of stage 3, and the output of stage 3 may be used as the input of stage 4.

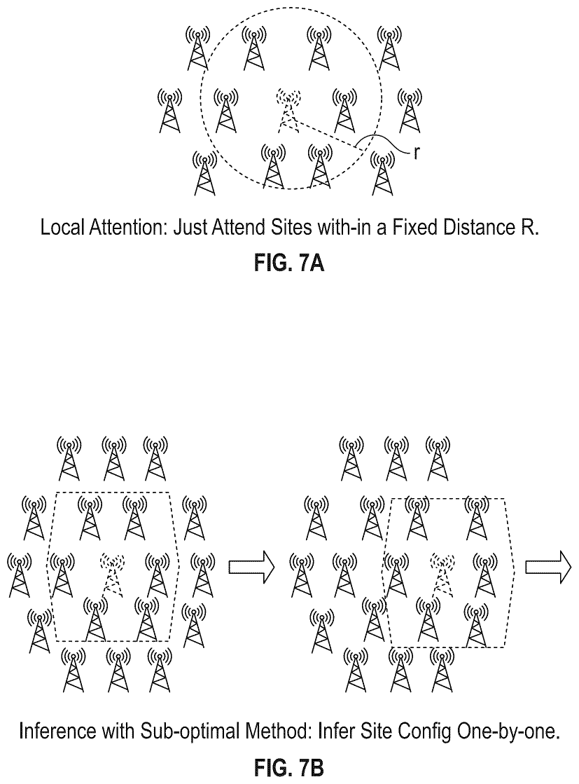

As jointly optimizing the entire network is generally not feasible, FIGS. 7A and 7B present two possible network control and optimization schemes that may be used. FIG. 7A illustrates jointly optimizing cell sites within a specified distance R from the candidate “center site.” The network of cell sites would be partitioned into non-overlapping groupings, with each group separately controlled and optimized.

FIG. 7B illustrates another possible scheme, where each site is configured independently, but takes into account the configuration of the nearest neighboring sites. As the network optimizes each site, it moves the window of neighboring sites to consider in the optimization of the candidate site that is currently being optimized. This is reflected in the dashed hexagon moving over one site, and the new candidate site for optimization and control is now centered (in dashed lines).

Embodiments of the disclosed technologies provide numerous advantages compared with current systems. The disclosed neural predictor saves energy by dynamically configuring band power while keeping throughput intact.

With the disclosed technologies, the capacity of sites may vary rapidly. With the current manual approach, operators generally avoid changing the capacity of cells faster than every 5 minutes. The disclosed technologies have no such limitation, and can change the capacity of sites as fast as every few seconds.

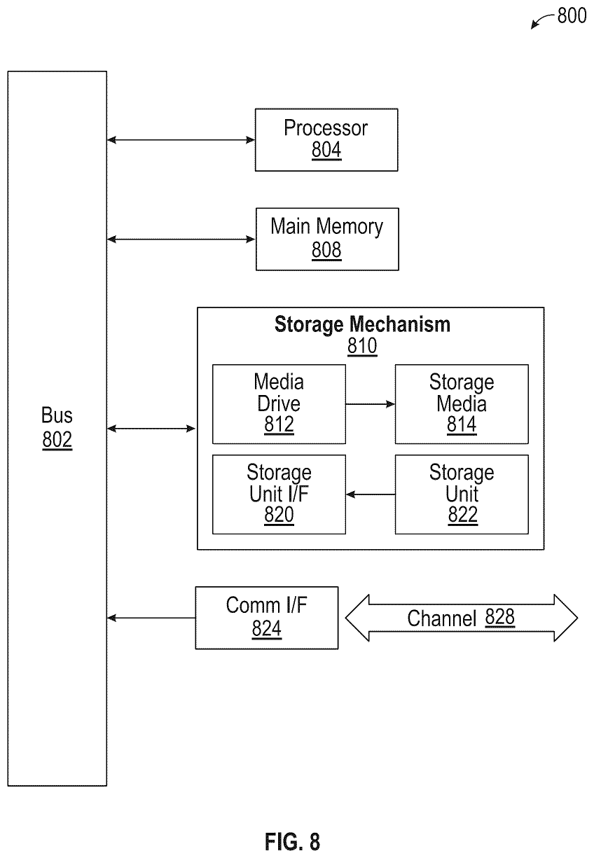

In some embodiments, the system does not control the coverage band(s). In such embodiments, each site meets 911 requirements, and always maintains a minimum amount of coverage.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s). Communications or network interface(s) interface might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for machine learning-assisted energy saving in a radio access network (RAN), the method comprising:
receiving first data collected from the RAN, wherein the first data comprises imbalanced normal-operation data and restricted-operation data of the RAN;
generating second data using a network emulator, wherein the second data includes synthetic normal-operation data and synthetic restricted-operation data;
training the network emulator to align the second data with the first data by adjusting one or more parameters of the network emulator;
training a neural predictor using the aligned second data, wherein the neural predictor predicts network performance metrics and generates uncertainty scores about the predicted network performance metrics; and
controlling one or more base stations in the RAN based on an output of the neural predictor, wherein the controlling comprises sending instructions to selectively reduce capacity during periods of low traffic, resulting in energy savings in the RAN.

2. The method of claim 1, further comprising:
collecting third data during a shadowing phase, wherein the shadowing phase comprises passively monitoring network operations without sending control instructions to the network, and the third data includes performance data observed from both normal-operation scenarios and restricted-operation scenarios.
augmenting a training dataset of the neural predictor by incrementally integrating the third data with the first data or the second data; and
finetuning the neural predictor using the augmented training dataset to reduce predictive uncertainty in conditions underrepresented by the first data and correct biases in the second data.

3. The method of claim 2, wherein the finetuning the neural predictor comprises:
periodically updating the neural predictor using the collected third data during the shadowing phase to incrementally refine predictions of the neural predictor for both typical and edge-case network scenarios.

4. The method of claim 2, wherein the finetuning the neural predictor comprises:
combining the third data with first data as the augmented training dataset; and
retraining the neural predictor using the augmented training dataset to reduce the uncertainty scores in low-data regions and mitigating over-reliance on synthetic data in the second data.

5. The method of claim 1, wherein the training the neural predictor to align the second data with the first data comprises:
applying Bayesian optimization with an upper confidence bound acquisition function to adjust one or more parameters of the network emulator, the adjustment being guided by a reward function that quantifies a degree of alignment between the first data and the second data.

6. The method of claim 5, wherein the reward function is computed on a per-site basis using one or more key performance indicators (KPIs) for each base station in the second data against corresponding KPIs in the first data, and aggregating the per-site comparisons into a global alignment score used to guide the adjustment of the parameters.

7. The method of claim 1, wherein the parameters of the network emulator include at least one parameter for mobile user equipment (UEs) and stationary UEs in each site, at least one throughput-related parameter for mobile UEs and stationary UEs, and at least one speed parameter for stationary UEs.

8. The method of claim 1, wherein the controlling one or more base stations in the radio access network comprises:
projecting user traffic levels within a cluster of base stations based on the output of the neural predictor;
selectively deactivating one or more radio carriers, frequency bands, or entire sectors when the projected traffic levels indicate low demand, thereby reducing power consumption during off-peak hours; and
rerouting user traffic onto remaining active carriers to maintain service continuity.

9. The method of claim 1, wherein the controlling one or more base stations in the radio access network comprises:
obtaining predicted traffic distributions among a plurality of cells or sites based on the output of the neural predictor;
adjusting transmit power levels or antenna configurations of the plurality of cells or sites according to the predicted traffic distributions to conserve energy in geographic areas with lower user demand;
automatically modulating transmission power output of the plurality of cells or sites to align with predicted user demands while using reduced energy expenditure; and
increasing transmit power output in response to predicted coverage needs in specific geographic areas to prevent service degradation and maintain throughput targets.

10. The method of claim 1, wherein the neural predictor comprises:
an intra-cell neural network configured to capture site-specific features;
a time-series neural network configured to extract temporal dependencies; and
a transformer encoder configured to model inter-site interactions.

11. The method of claim 10, wherein the site-specific features captured by the intra-cell neural network includes site-specific key performance indicators (KPIs), past actions, and proposed future actions, and
the intra-cell neural network comprises a fully-connected neural network configured to transform the site-specific features into a compact latent representation, thereby enabling subsequent stages to operate with reduced dimensionality.

12. The method of claim 10, wherein the temporal dependencies comprise both normal and restricted operations in network usage, interference levels, and user behaviors, and
the time-series neural network uses at least one of a Transformer Decoder, Long Short-Term Memory (LSTM) network, or Gated Recurrent Unit (GRU) network, to generate a time-evolving feature vector for each site.

13. The method of claim 10, wherein, to model the model inter-site interactions, the transformer encoder is further configured to:
track interactions among neighboring base stations including spillover effects and user redistribution.

14. A system, comprising:
one or more hardware processors; and
one or more non-transitory machine-readable storage media encoded with instructions that, when executed by the one or more hardware processors, cause the system to perform operations comprising:
receiving first data collected from the RAN, wherein the first data comprises imbalanced normal-operation data and restricted-operation data of the RAN;
generating second data using a network emulator, wherein the second data includes synthetic normal-operation data and synthetic restricted-operation data;
training the network emulator to align the second data with the first data by adjusting one or more parameters of the network emulator;
training a neural predictor using the aligned second data, wherein the neural predictor predicts network performance metrics and generates uncertainty scores about the predicted network performance metrics; and
controlling one or more base stations in the RAN based on an output of the neural predictor, wherein the controlling comprises sending instructions to selectively reduce capacity during periods of low traffic, resulting in energy savings in the RAN.

15. The system of claim 14, wherein the operations further comprising:
collecting third data during a shadowing phase, wherein the shadowing phase comprises passively monitoring network operations without sending control instructions to the network, and the third data includes performance data observed from both normal-operation scenarios and restricted-operation scenarios.
augmenting a training dataset of the neural predictor by incrementally integrating the third data with the first data or the second data; and
finetuning the neural predictor using the augmented training dataset to reduce predictive uncertainty in conditions underrepresented by the first data and correct biases in the second data.

16. The system of claim 14, wherein the parameters of the network emulator include at least one parameter for mobile user equipment (UEs) and stationary UEs in each site, at least one throughput-related parameter for mobile UEs and stationary UEs, and at least one speed parameter for stationary UEs.

17. The system of claim 14, wherein the controlling one or more base stations in the RAN comprises:
projecting user traffic levels within a cluster of base stations based on the output of the neural predictor; selectively deactivating one or more radio carriers, frequency bands, or entire sectors when the projected traffic levels indicate low demand, thereby reducing power consumption during off-peak hours; and
rerouting user traffic onto remaining active carriers to maintain service continuity.

18. The system of claim 14, wherein the controlling one or more base stations in the radio access network comprises:
obtaining predicted traffic distributions among a plurality of cells or sites based on the output of the neural predictor;
adjusting transmit power levels or antenna configurations of the plurality of cells or sites according to the predicted traffic distributions to conserve energy in geographic areas with lower user demand;
automatically modulating transmission power output of the plurality of cells or sites to align with predicted user demands while using reduced energy expenditure; and
increasing transmit power output in response to predicted coverage needs in specific geographic areas to prevent service degradation and maintain throughput targets.

19. The system of claim 14, wherein the neural predictor comprises:
an intra-cell neural network configured to capture site-specific features;
a time-series neural network configured to extract temporal dependencies; and
a transformer encoder configured to model inter-site interactions.

20. Non-transitory computer-readable storage media storing instructions that, when executed by one or more processors, cause the one or more processors to perform operations comprising:
receiving first data collected from the RAN, wherein the first data comprises imbalanced normal-operation data and restricted-operation data of the RAN;
generating second data using a network emulator, wherein the second data includes synthetic normal-operation data and synthetic restricted-operation data;
training the network emulator to align the second data with the first data by adjusting one or more parameters of the network emulator;
training a neural predictor using the aligned second data, wherein the neural predictor predicts network performance metrics and generates uncertainty scores about the predicted network performance metrics; and
controlling one or more base stations in the RAN based on an output of the neural predictor, wherein the controlling comprises sending instructions to selectively reduce capacity during periods of low traffic, resulting in energy savings in the RAN.
